(19) United States
(12) Patent Application Publication
(10) Pub. No.: US 2016/0203746 A1
(43) Pub. Date: Jul. 14, 2016

(54) DISPLAY DEVICE

(71) Applicant: Samsung Display Co., Ltd., Yongin-si (KR)

(72) Inventors: Jundal KIM, Asan-si (KR); Sujin KIM, Ulsan (KR); Yoonsik PARK, Yongin-si (KR); Jang hee PARK, Siheung-si (KR); Jong jae LEE, Hwaseong-si (KR); Se Young HEO, Seoul (KR); Junki HONG, Bucheon-si (KR)

(21) Appl. No.: 14/919,162

(22) Filed: Oct. 21, 2015

(30) Foreign Application Priority Data
Jan. 13, 2015 (KR) 10-2015-0006152

(51) Int. Cl. G09G 3/20

(52) U.S. Cl. CPC G09G 3/20; G09G 2320/08; G09G 2330/021; G09G 2310/08

(57) ABSTRACT

A display device includes: a display panel including a plurality of pixels; a driving circuit configured to control the plurality of pixels; and a power controller configured to apply an output voltage to the driving circuit and to receive a feedback signal indicating an input level of the output voltage applied at an input of the driving circuit. The power controller is configured to adjust an output level of the output voltage in response to the feedback signal.

### CROSS-REFERENCE TO RELATED APPLICATION

This application claims priority from and the benefit of Korean Patent Application No. 10-2015-0006152, filed on Jan. 13, 2015, which is hereby incorporated by reference for all purposes as if fully set forth herein.

### BACKGROUND

1. Field

Exemplary embodiments relate to a display device, and more particularly, to a display device that includes a power controller adjusting an output voltage according to a voltage level input to a driving circuit.

2. Discussion of the Background

A display device may include a display panel displaying an image, a gate driving unit and data driving unit driving the display panel, and a control unit controlling the gate driving unit and data driving unit. The control unit may be configured to transmit a control signal to the gate driving unit and data driving unit and transmit an image signal to the data driving unit. Also, the control unit may be configured to supply a voltage to the gate driving unit and data driving unit.

If a voltage is applied and a current flows along a wire, the level of electric potential may decrease by a parasite resistance present in the wire. Specifically, the level of electric potential output from the control unit may be different from the level of electric potential applied to the input of the gate driving unit or data driving unit. Due to the difference between the level of output voltage and the level of input voltage, the gate driving unit or data driving unit may cause a malfunction or an unsatisfactory operation.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a display device including an enhanced voltage control function to ensure enhanced reliability.

Additional aspects will be set forth in the detailed description which follows, and, in part, will be apparent from the disclosure, or may be learned by practice of the inventive concept.

An exemplary embodiment discloses a display device including: a display panel including a plurality of pixels; a driving circuit configured to control the plurality of pixels; and a power controller configured to apply an output voltage to the driving circuit and to receive a feedback signal indicating an input level of the output voltage applied at an input of the driving circuit. The power controller is configured to adjust an output level of the output voltage in response to the feedback signal.

An exemplary embodiment discloses a display device including: a display panel including a plurality of pixels, each pixel being connected to a drain electrode of a transistor; a data driving circuit connected to a data line connected to a source electrode of the transistor to control the plurality of pixels; a gate driving circuit connected to a gate line connected to a gate electrode of the transistor to provide a gate signal; and a power controller configured to apply an output voltage to the data driving circuit and to receive a feedback signal from at least one of the data driving circuit and the gate driving circuit. The power controller is configured to adjust an output level of the output voltage in response to the feedback signal.

An exemplary embodiment also discloses a display device including: a display panel including a plurality of pixels, each pixel being connected to a drain electrode of a transistor; a data driving circuit connected to a data line connected to a source electrode of the transistor to control the plurality of pixels; a gate driving circuit connected to a gate line connected to a gate electrode of the transistor to provide a gate signal; a timing controller to receive a feedback signal from at least one of the data driving circuit and the gate driving circuit; and a power controller configured to apply an output voltage to the data driving circuit and to adjust an output level of the output voltage in response to the feedback signal.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept:

FIG. 1 is a block diagram of a display device according to an exemplary embodiment.

FIG. 2 is a graph showing a change in a level of first voltage when the first voltage is transmitted through a first path according to an exemplary embodiment.

FIG. 3 is a flowchart illustrating an operating method of a display device according to an exemplary embodiment.

FIG. 4 is a block diagram of a first example of transmitting a feedback signal according to an exemplary embodiment.

FIG. 5 is a block diagram of a second example of transmitting a feedback signal according to an exemplary embodiment.

FIG. 6 is a block diagram of a third example of transmitting a feedback signal according to an exemplary embodiment.

FIG. 7 is a block diagram of a fourth example of transmitting a feedback signal according to an exemplary embodiment.

FIG. 8 is a block diagram of a fifth example of transmitting a feedback signal according to an exemplary embodiment.

FIG. 9 is a block diagram of a sixth example of transmitting a feedback signal according to an exemplary embodiment.

FIG. 10 is a block diagram of a display device according to an exemplary embodiment.

FIG. 11 is a block diagram of a display device according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

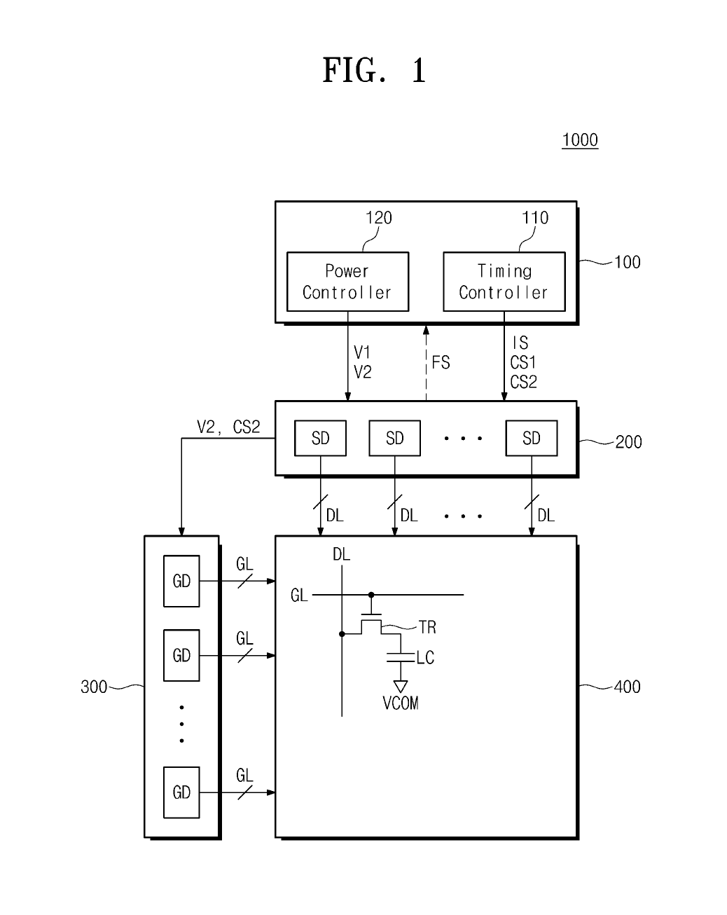

FIG. 1 is a block diagram of a display device according to an exemplary embodiment. Referring to FIG. 1, the display device 1000 includes a control unit 100, a data driving unit 200, a gate driving unit 300, and a display panel 400.

The control unit 100 includes a timing controller 110 and a power controller 120. The timing controller 110 may transmit an image signal IS to the data driving unit 200. For example, the image signal IS may include an RGB signal, which controls the display panel 400 to display red, green, or blue images or the combination thereof. The timing controller 110 may transmit a first control signal CS1 to the data driving unit 200. The timing controller 110 may transmit a second control signal CS2 to the gate driving unit 300 through the data driving unit 200. The timing controller 110 may use the image signal IS, first control signal CS1, and second control signal CS2 to control the data driving unit 200 and gate driving unit 300.

The power controller 120 may supply a first voltage V1 to the data driving unit 200. The power controller 120 may supply a second voltage V2 to the gate driving unit 300 through the data driving unit 200. For example, the power controller 120 may include a power management integrated circuit (PMIC).

The data driving unit 200 may receive the image signal IS and first control signal CS1 from the timing controller 110. The data driving unit 200 may control the voltages of data lines DL in response to the image signal IS and first control signal CS1. The data driving unit 200 may receive the first voltage V1 from the power controller 120. The data driving unit 200 may operate based on the first voltage V1. The data driving unit 200 may include a plurality of source driving circuits SD. The plurality of source driving circuits SD may be configured to control the plurality of data lines DL, respectively.

The gate driving unit 300 may receive the second control signal CS2 from the timing controller 110. The gate driving unit 300 may control the voltages of gate lines GL in response to the second control signal CS2. The gate driving unit 300 may receive the second voltage V2 from the power controller 120. The gate driving unit 300 may operate based on the second voltage V2. The gate driving unit 300 may include a plurality of gate driving circuits GD. The plurality of source driving circuits SD may be configured to control the plurality of gate lines GL, respectively.

The display panel 400 may be connected to the data driving unit 200 through the plurality of data lines DL and connected to the gate driving unit 300 through the plurality of gate lines GL. The display panel 400 may include a plurality of pixels that are provided at locations at which the plurality of data lines DL intersect with the plurality of gate lines GL. As an example, a single pixel is shown in the display panel 400. Each pixel may include a transistor TR and a capacitor LC. The source of the transistor TR of each pixel is connected to a corresponding data line DL. The gate of the transistor TR of each pixel is connected to a corresponding gate line GL. The drain of the transistor TR of each pixel is connected to the capacitor LC. The capacitor LC may be connected between the drain of the transistor TR and a node to which a common voltage VCOM is supplied. A liquid crystal may be filled between two electrodes of the capacitor LC. The liquid crystal in the capacitor LC may have a rotation angle that varies depending on the difference between the drain voltage of the transistor TR and the common voltage VCOM.

In an exemplary embodiment, the timing controller 110 and power controller 120 may be provided in a single printed board assembly (PBA). For example, the timing controller 110 and power controller 120 may be provided in a control PBA (C-PBA).

In an exemplary embodiment, the control unit 100 may be connected to the data driving unit 200 through a connector. For example, the control unit 100 may be connected to the data driving unit 200 through a flexible flat cable (FFC) connector.

In an exemplary embodiment, the data driving unit 200 may include source driving circuits 200, and a source PBA (S-PBA) connecting the source driving circuits 200 and the FFC connector.

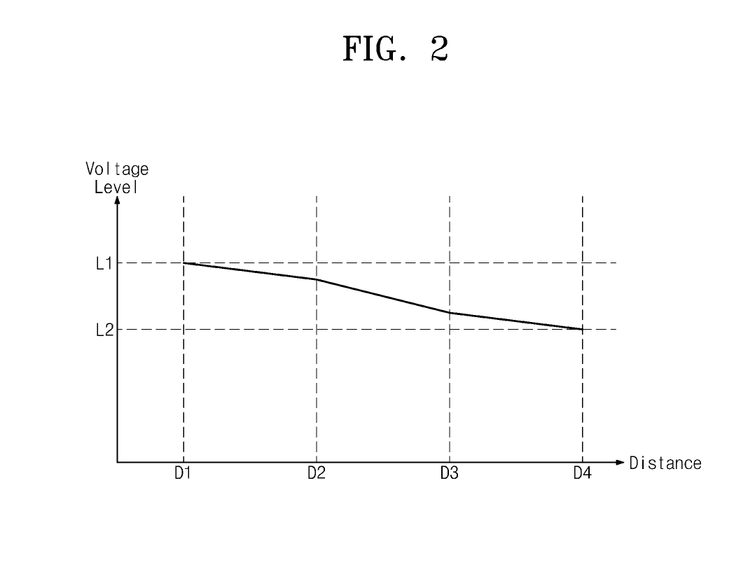

In the above-described structure, the first voltage V1 output from the power controller 120 is transmitted to the source driving circuits SD through a first path. The first path may include a first wire on the C-PBA of the control unit 100, a second wire on the FFC connector, and a third wire on the S-PBA of the data driving unit 200. The above-described first to third wires may have parasite resistors, respectively. Thus, while the first voltage V1 is applied to the above-described first to third wires, the level of the first voltage V1 may decrease. Specifically, the level (output level) of the first voltage V1 output from the power controller 120 may be different from the level (input level) of the first voltage V1 input to the source driving circuits SD. For example, the input level of the first voltage V1 may be lower than the output level of the first voltage V1. A change in the level of the first voltage V1 through the first path is shown in FIG. 2.

Referring to FIG. 2, a horizontal axis indicates a distance from the power controller 120, and a vertical axis indicates the level of the first voltage V1. In FIG. 2, a first distance D1 indicates an output pin of the power controller 120 from which the first voltage V1 is output. That is, the first distance D1 may indicate ‘0’. At the first distance D1, the level of the first voltage V1, i.e., output level may have a first level L1.

A second distance D2 indicates a point at which the first wire on the C-PBA is connected to the second wire on the FFC connector. A third distance D3 indicates a point at which the second wire on the FFC connector is connected to the third wire on the S-PBA. A fourth distance D4 indicates a point at which the third wire on the S-PBA is connected to an input pin of the source driving circuits SD. At the fourth distance D4, the level of the first voltage V1, i.e., input level may have a second level L2.

As shown in FIG. 2, if the level of the first voltage V1 is applied at the output pin of the power controller 120 and a current flows to the input pin of the source driving circuits SD, the level of the first voltage V1 decreases from the first level L1 to the second level L2. At the output of the power controller 120 corresponding to the distance D1, the first voltage V1 has the first level L1. However, at the input of the source driving circuits corresponding to the distance D4, the first voltage V1 has the second level L2.

In order for the source driving circuits SD to perform a normal operation, the input level of the first voltage V1 supplied to the source driving circuits SD is controlled such that the input level of the first voltage V1 supplied to the source driving circuits SD is set within a normal operation range of the source driving circuits SD. However, when the input level of the first voltage V1 is lower than the output level as described above, the input level of the first voltage V1 input to the source driving circuits SD may be out of the normal operation range or have a significantly small margin even if the input level belongs to the normal operation range, even when the power controller 120 outputs the first voltage V1 having an output level belonging to the normal operation range.

Referring back to FIG. 1 in order to solve a limitation or possible problems as described above, the data driving unit 200 may be configured to transmit, to the control unit 100, a feedback signal FS indicating the input level of the first voltage V1 input to the source driving circuits SD. The control unit 100 or power controller 120 is configured to adjust the output level of the first voltage V1 in response to the feedback signal FS. For example, the power controller 120 may adjust the output level of the first voltage V1 so that the input level of the first voltage V1 belongs to the normal operation range (and has a larger margin than a reference value). Thus, the reliability of the source driving circuits SD of the data driving unit 200 is enhanced and the reliability of the display device 1000 is enhanced.

In an exemplary embodiment, the feedback signal FS may be transmitted through a signal path that is different from signal paths through which a current flows between points at which the first voltage V1 and the second voltage V2 are applied. Feedback signal FS may be transmitted through a signal path that is different from signal paths through which the image signal IS, the first control signal CS1, and the second control signal CS2 are transmitted.

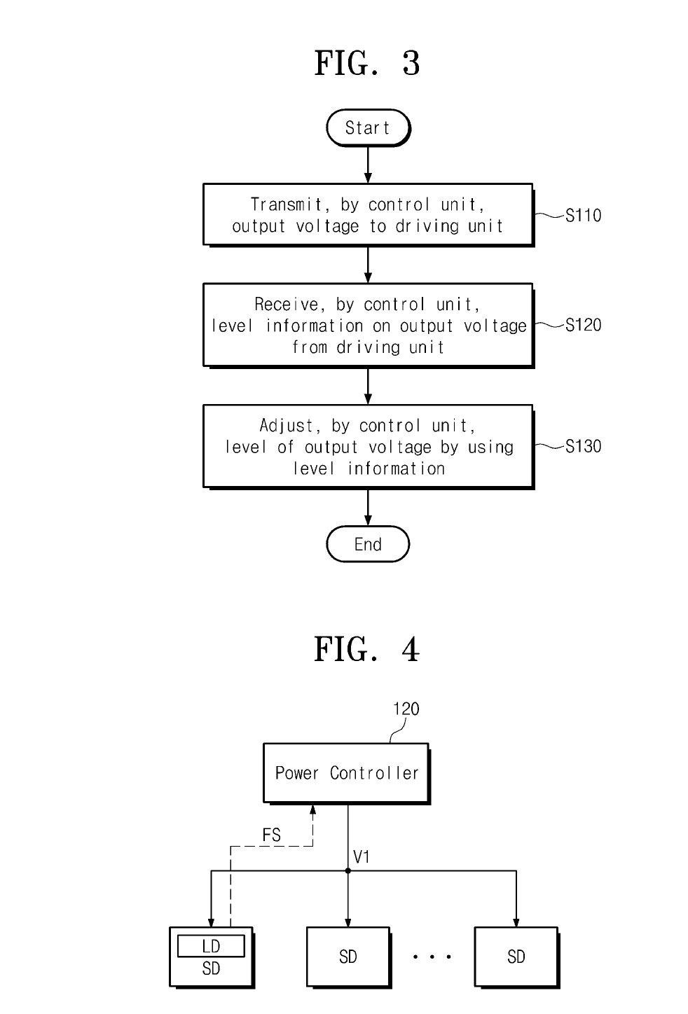

FIG. 3 is a flowchart of an operating method of the display device 1000 according to an exemplary embodiment. Referring to FIG. 1 and FIG. 3, in operation S110, the control unit 100 applies the output voltage V1 or V2 to the driving unit 200 or 300. In operation S120, the control unit 100 receives level information on the output voltage V1 or V2, i.e., information on an input level, from the data driving unit 200 or the gate driving unit 300, respectively. In operation S130, the control unit 100 may use received level information to adjust the level of the output voltage V1 or V2, i.e., output level.

FIG. 4 is a block diagram of a first example of transmitting the feedback signal FS according to an exemplary embodiment. For concise description, relevant components for describing the transmission of the feedback signal FS are shown in FIG. 4. However, components not relevant for the description of the transmission of the feedback signal FS are omitted from FIG. 4. Referring to FIG. 4, the power controller 120 supplies the first voltage V1 to the plurality of source driving circuits SD, in common. As shown in FIG. 4, the first voltage V1 may be applied to each source driving circuit SD by configuring parallel circuit connections.

A particular one of the plurality of source driving circuits SD may include a level detector LD. The level detector LD may detect the input level of the first voltage V1. Information indicating the input level detected by the level detector LD may be transmitted to the power controller 120 as the feedback signal FS. The level detector LD may be configured in more than one source driving circuits SD.

In an exemplary embodiment, the particular source driving circuit SD including the level detector LD may include a pin configured to output the feedback signal FS. The power controller 120 may include a pin configured to receive the feedback signal FS. The pin to which the feedback signal FS is transmitted may be a dedicated pin or a shared pin that is shared with another signal.

In an exemplary embodiment, the particular source driving circuit SD including the level detector LD may be determined according to the distance between source driving circuits SD and the power controller 120. The above-described distance may indicate a path distance along which a current flows based on the first voltage V1 being applied. For example, the level detector LD may be provided to a source driving circuit SD having the longest distance from the power controller 120 among the source driving circuits SD. As another example, the level detector LD may be provided to a source driving circuit SD having the shortest distance from the power controller 120 among the source driving circuits SD. As another example, the level detector LD may be provided to a source driving circuit SD having the intermediate distance from the power controller 120 among the source driving circuits SD.

In an exemplary embodiment, the particular source driving circuit SD including the level detector LD may be determined according to the input level of the first voltage V1. For example, the level detector LD may be provided to a source driving circuit SD at which the input level of the first voltage V1 is lowest, among the source driving circuits SD. As another example, the level detector LD may be provided to a source driving circuit SD at which the input level of the first voltage V1 is highest, among the source driving circuits SD. As another example, the level detector LD may be provided to a source driving circuit SD at which the input level of the first voltage V1 has an intermediate value, among the source driving circuits SD. The intermediate value may be determined from selecting the value close to the average value among the input levels of the first voltage V1 applied to the source driving circuits SD or the median value.

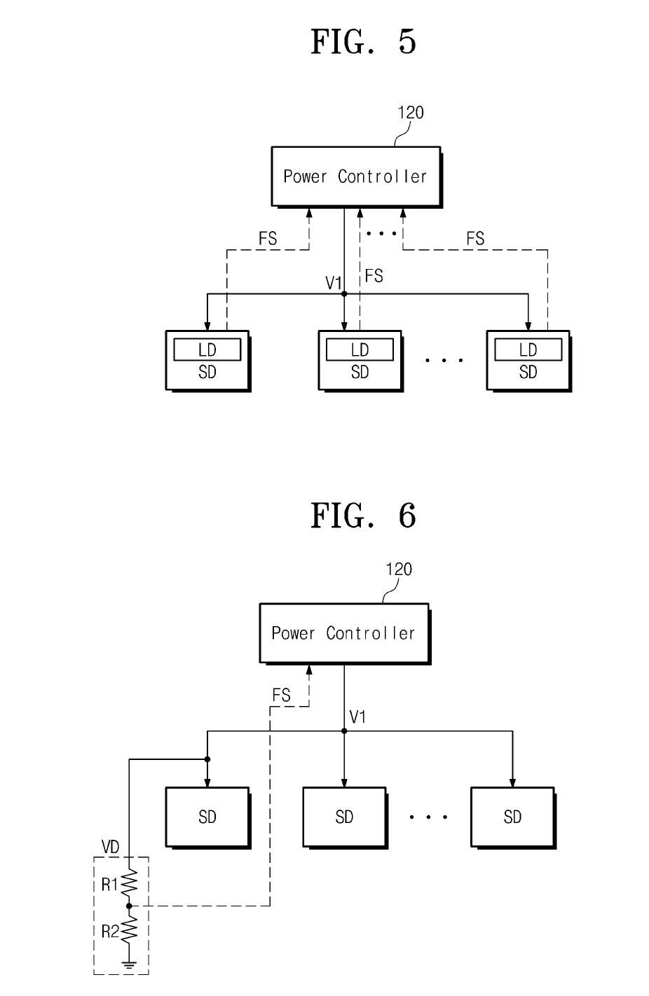

FIG. 5 is a block diagram of a first example of transmitting the feedback signal FS according to an exemplary embodiment. For concise description, relevant components for describing the transmission of the feedback signal FS are shown in FIG. 5, and components not relevant to the description of the feedback signal FS are omitted from FIG. 5. Referring to FIG. 5, the power controller 120 supplies the first voltage V1 to the plurality of source driving circuits SD, in common. As shown in FIG. 5, the first voltage V1 may be applied to each source driving circuit SD by configuring parallel circuit connections.

Level detectors LD may be provided to a plurality of source driving circuits SD, respectively. For example, the level detectors LD may be provided to all or some of the source driving circuits SD. Source driving circuits SD having the level detectors LD may transmit feedback signals FS to the power controller 120, respectively. The power controller 120 may adjust the output level of the first voltage V1 based on the plurality of feedback signals FS received.

In an exemplary embodiment, the power controller 120 may adjust an output level according to a feedback signal FS indicating the highest input level among the plurality of feedback signals FS. The power controller 120 may adjust the output level according to a feedback signal FS indicating the lowest input level among the plurality of feedback signals FS. The power controller 120 may adjust the output level according to a feedback signal FS indicating an intermediate input level among the plurality of feedback signals FS. The intermediate input level may be determined from selecting the value close to the average value among the input levels or the median value. The power controller 120 may calculate the average value of input levels that the plurality of feedback signals FS indicate, and adjust the output level according to the calculated average value. Further, the power controller 120 may adjust an output level of the first voltage V1 within a range determined based on a feedback signal FS indicating the highest input level among the plurality of feedback signals FS and a feedback signal FS indicating the lowest input level among the plurality of feedback signals FS. Thus, the power controller 120 may adjust the output level of the first voltage V1 such that the source driving circuits SD corresponding to the highest input level and the source driving circuits SD corresponding to the lowest input level are applied with an adjusted input voltage within a normal operation range.

FIG. 6 is a block diagram of a third example of transmitting the feedback signal FS according to an exemplary embodiment. For concise description, relevant components for describing the transmission of the feedback signal FS are shown in FIG. 6, and components not relevant for the description are omitted from FIG. 6. Referring to FIG. 6, the power controller 120 supplies the first voltage V1 to the plurality of source driving circuits SD, in common. As shown in FIG. 6, the first voltage V1 may be applied to each source driving circuit SD by configuring parallel circuit connections.

A voltage divider VD may be connected to a voltage input pin of a particular one of the plurality of source driving circuits SD. The voltage divider VD may use a first resistor R1 and a second resistor R2 to divide the input level of the first voltage V1. The input level of the first voltage V1 divided by the first resistor R1 and the second resistor R2 may be provided to the power controller 120 as a feedback signal. In this configuration, the feedback voltage corresponds to R2*V1/(R1+R2), where V1 is a voltage applied at the upper node of the first resistor R1. As an example, the first resistor R1 and the second resistor R2 may be high resistors.

When the voltage divider VD is branched from an input of a particular source driving circuit SD, the source driving circuit may not perform a function associated with the feedback signal FS and not have a configuration associated with the feedback signal FS. When the voltage divider VD is internally disposed in a particular source driving circuit SD, the particular source driving circuit SD may include a pin configured to output the feedback signal FS. The power controller 120 may include a pin configured to receive the feedback signal FS. The pin to which the feedback signal FS is transmitted may be a dedicated pin or a shared pin that is shared with another signal.

In an exemplary embodiment, the particular source driving circuit SD including the voltage divider VD may be determined according to the distance between source driving circuits SD and the power controller 120. The above-described distance may indicate a path distance along which a current flows by the applied first voltage V1 between the output of the power controller 120 and the input of a source driving circuit SD. For example, the voltage divider VD may be provided to a source driving circuit SD having the longest distance from the power controller 120 among the source driving circuits SD. As another example, the voltage divider VD may be provided to a source driving circuit SD having the shortest distance from the power controller 120 among the source driving circuits SD. As another example, the voltage divider VD may be provided to a source driving circuit SD having an intermediate distance from the power controller 120 among the source driving circuits SD. The intermediate distance may be determined from selecting the value close to the average distance with respect to the source driving circuits SD or the median value.

In an exemplary embodiment, the particular source driving circuit SD including the voltage divider VD may be determined according to the input level of the first voltage V1. For example, the voltage divider VD may be provided to a source driving circuit SD at which the input level of the first voltage V1 is lowest, among the source driving circuits SD. As another example, the voltage divider VD may be provided to a source driving circuit SD at which the input level of the first voltage V1 is highest, among the source driving circuits SD. As another example, the voltage divider VD may be provided to a source driving circuit SD at which the input level of the first voltage V1 has an intermediate value, among the source driving circuits SD.

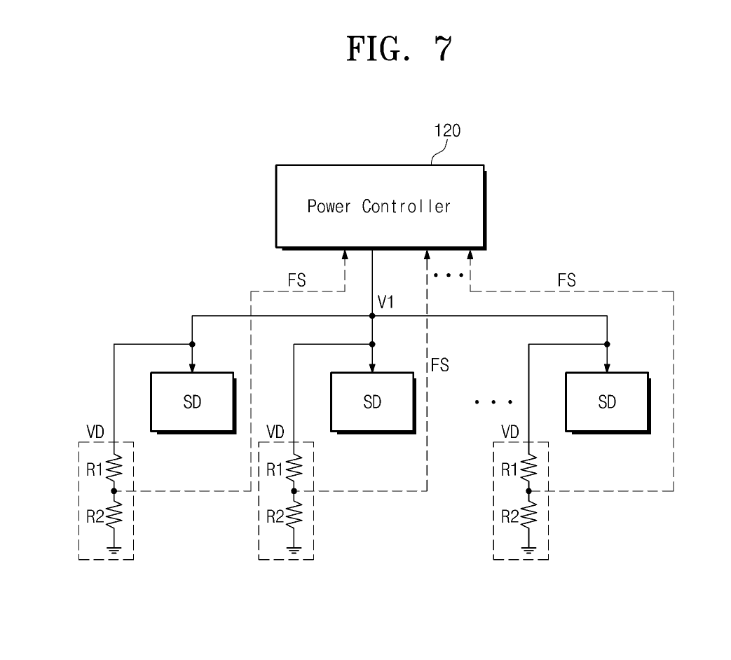

FIG. 7 is a block diagram of a fourth example of transmitting the feedback signal FS according to an exemplary embodiment. For concise description, relevant components for describing the transmission of the feedback signal FS are shown in FIG. 7, and components not relevant for the description are omitted from FIG. 7. Referring to FIG. 7, the power controller 120 supplies the first voltage V1 to the plurality of source driving circuits SD, in common. As shown in FIG. 7, the first voltage V1 may be applied to each source driving circuit SD by configuring parallel circuit connections.

Voltage dividers VD may be provided to the plurality of source driving circuits SD, respectively. For example, the level detectors LD may be provided to all or some of the plurality of source driving circuits SD. Levels divided by the voltage dividers VD may be detected to the power controller 120 as feedback signals FS, respectively. Specifically, the voltage level between a first resistor R1 and a second resistor R2 may be detected and transmitted to the power controller 120. The power controller 120 may adjust the output level of the first voltage V1 based on the plurality of feedback signals FS received.

For example, the power controller 120 may adjust an output level according to a feedback signal FS indicating the highest input level among the plurality of feedback signals FS. The power controller 120 may adjust the output level according to a feedback signal FS indicating the lowest input level among the plurality of feedback signals FS. The power controller 120 may adjust the output level according to a feedback signal FS indicating an intermediate input level among the plurality of feedback signals FS. The power controller 120 may calculate the average value of input levels that the plurality of feedback signals FS indicate, and adjust the output level according to a calculated average value.

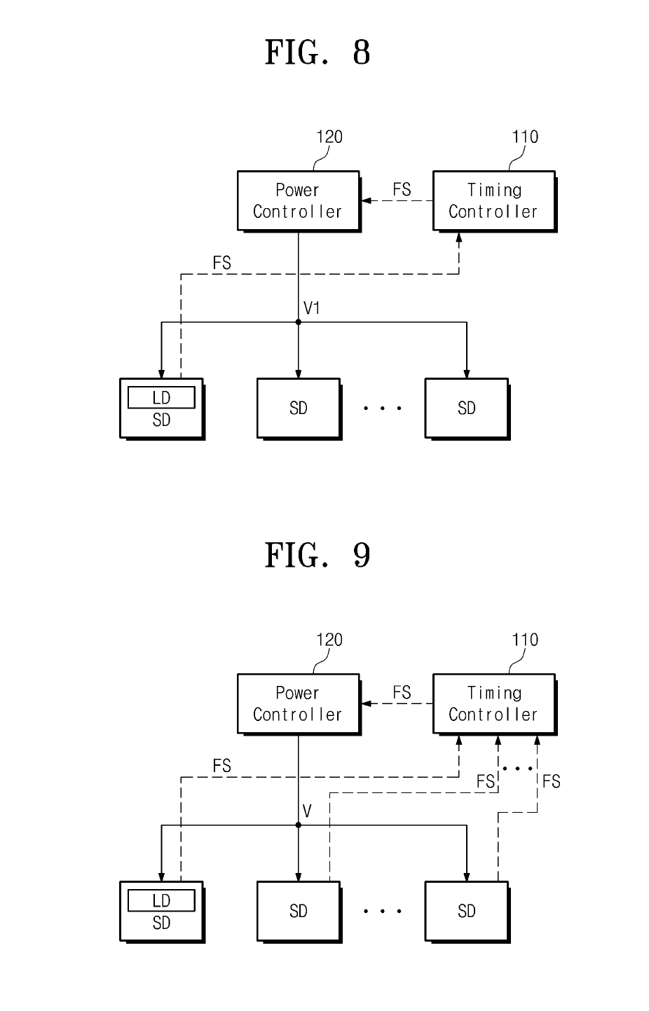

FIG. 8 is a block diagram of a fifth example of transmitting the feedback signal FS according to an exemplary embodiment. For concise description, relevant components for describing the transmission of the feedback signal FS are shown in FIG. 8, and components not relevant for the description are omitted from FIG. 8. Referring to FIG. 8, the power controller 120 supplies the first voltage V1 to the plurality of source driving circuits SD, in common. As shown in FIG. 8, the first voltage V1 may be applied to each source driving circuit SD by configuring parallel circuit connections.

A particular one of the plurality of source driving circuits SD may include a level detector LD. The level detector LD may detect the input level of the first voltage V1. Information indicating the input level detected by the level detector LD may be transmitted to the timing controller 110 as a feedback signal FS.

As an example, the particular source driving circuit SD including the level detector LD may include a pin configured to output the feedback signal FS. The timing controller 110 may include a pin configured to receive the feedback signal FS. For example, the particular source driving circuit SD and timing controller 110 may communicate the feedback signal FS through I2C communication, e.g., Inter-integrated circuit communication, but is not limited thereto. The timing controller 110 may be a master device of the I2C communication and the particular source driving circuit SD may be a slave device of the I2C communication. More specifically, the timing controller 110 may be configured to provide a clock signal to the particular source driving circuit SD.

The timing controller 110 may transmit the feedback signals FS received from the particular source driving circuit SD, to the power controller 120. As an example, the timing controller 110 and power controller 120 may be configured to exchange information through the I2C communication. For example, the timing controller 110 may be configured to transmit voltage setup information to the power controller 120 through the I2C communication. The timing controller 110 may be a master device of the I2C communication and the power controller 120 may be a slave device of the I2C communication. More specifically, the timing controller 110 may be configured to provide a clock signal to the power controller 120. In addition to the voltage setup information, the timing controller 110 may be configured to further transmit the feedback signal FS through the I2C communication. The power controller 120 may adjust the output level of the first voltage V1 based on a received feedback signal FS.

In an exemplary embodiment, the particular source driving circuit SD including the level detector LD may be determined according to the distance between source driving circuits SD and the power controller 120. The above-described distance may indicate a path distance along which the input level of the first voltage V1 is changed. For example, the level detector LD may be provided to a source driving circuit SD having the longest distance from the power controller 120 among the source driving circuits SD. As another example, the level detector LD may be provided to a source driving circuit SD having the shortest distance from the power controller 120 among the source driving circuits SD. As another example, the level detector LD may be provided to a source driving circuit SD having an intermediate distance from the power controller 120 among the source driving circuits SD.

In an exemplary embodiment, the particular source driving circuit SD including the level detector LD may be determined according to the input level of the first voltage V1. For example, the level detector LD may be provided to a source driving circuit SD at which the input level of the first voltage V1 is lowest, among the source driving circuits SD. As another example, the level detector LD may be provided to a source driving circuit SD at which the input level of the first voltage V1 is highest, among the source driving circuits SD. As another example, the level detector LD may be provided to a source driving circuit SD at which the input level of the first voltage V1 has an intermediate value, among the source driving circuits SD.

FIG. 9 is a block diagram of a sixth example of transmitting the feedback signal FS according to an exemplary embodiment. For concise description, components relevant for describing the transmission of the feedback signal FS are shown in FIG. 9, and components not relevant for the description are omitted from FIG. 9. Referring to FIG. 9, the power controller 120 supplies the first voltage V1 to the plurality of source driving circuits SD, in common. As shown in FIG. 9, the first voltage V1 may be applied to each source driving circuit SD by configuring parallel circuit connections.

Level detectors LD may be provided to the plurality of source driving circuits SD, respectively. For example, the level detectors LD may be provided to all or some of the source driving circuits SD. Source driving circuits SD having the level detectors LD respectively may transmit feedback signals FS to the timing controller 110. The timing controller 110 may transmit the plurality of feedback signals FS received from the plurality of source driving circuit SD, to the power controller 120. For example, the timing controller 110 may transmit, to the power controller 120, all of the plurality of feedback signals FS, a feedback signal FS indicating the highest input level among the plurality of feedback signals FS, a feedback signal FS indicating the lowest input level among the plurality of feedback signals FS, a feedback signal FS indicating an intermediate input level among the plurality of feedback signals FS, or the average value of the input levels that the plurality of feedback signals FS indicate.

The power controller 120 may adjust the output level of the first voltage V1 based on all or one of the plurality of feedback signals FS received from the timing controller 110.

For example, the power controller 120 may adjust an output level according to a feedback signal FS indicating the highest input level among the plurality of feedback signals FS. The power controller 120 may adjust the output level according to a feedback signal FS indicating the lowest input level among the plurality of feedback signals FS. The power controller 120 may adjust the output level according to a feedback signal FS indicating an intermediate input level among the plurality of feedback signals FS. The power controller 120 may calculate the average value of input levels that the plurality of feedback signals FS indicate, and adjust the output level according to a calculated average value.

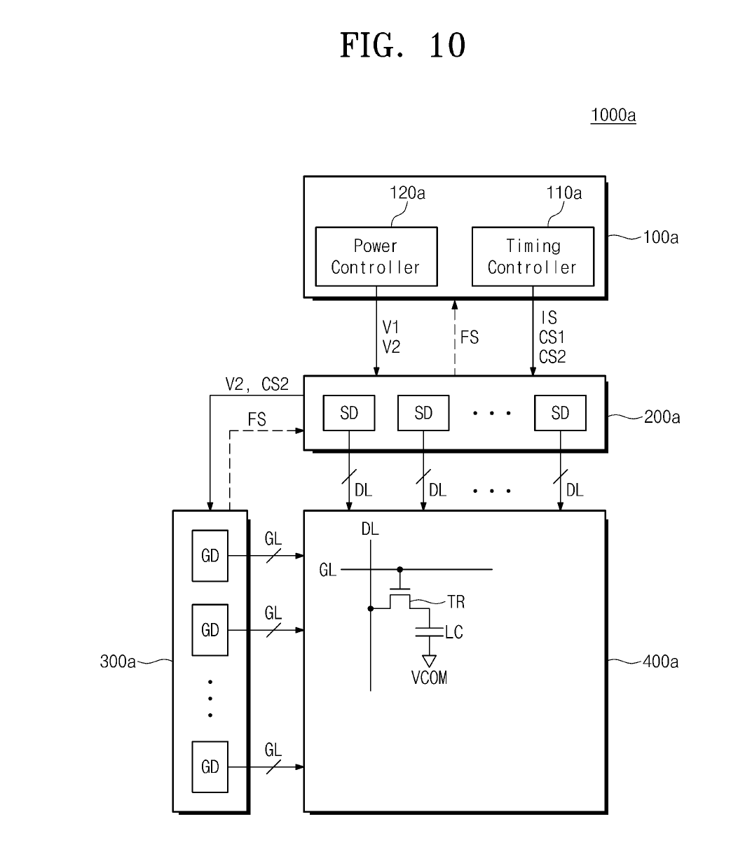

FIG. 10 is a block diagram of a display device according to an exemplary embodiment. Referring to FIG. 10, the display device 1000a includes a control unit 100a, a data driving unit 200a, a gate driving unit 300a, and a display panel 400a. The control unit 100a includes a timing controller 110a and a power controller 120a.

When compared with the display device 1000 in FIG. 1, the gate driving unit 300a instead of the data driving unit 200a may be configured to output the feedback signal FS. For example, the gate driving circuits of the gate driving unit 300a may be configured to transmit the feedback signal FS indicating the input level of the second voltage V2 to the control unit 100a through the data driving unit 200a. For example, the gate driving circuits GD may be configured to output the feedback signal FS based on at least one of exemplary embodiments described with reference to FIG. 4 to FIG. 9. For example, the exemplary embodiments described with reference to FIG. 4 to FIG. 9 may be equally applied to the gate driving circuits GD except that the source driving circuits SD in FIG. 4 to FIG. 9 are replaced with the gate driving circuits GD and the first voltage V1 is replaced with the second voltage V2. Thus, repetitive descriptions will be omitted. In FIG. 10, the feedback signal FS is provided from the gate driving unit 300a to the data driving unit 200a. The data driving unit 200a may transfer the feedback signal FS to the control unit 100a. However, the feedback signal FS may be directly provided to the control unit 100a.

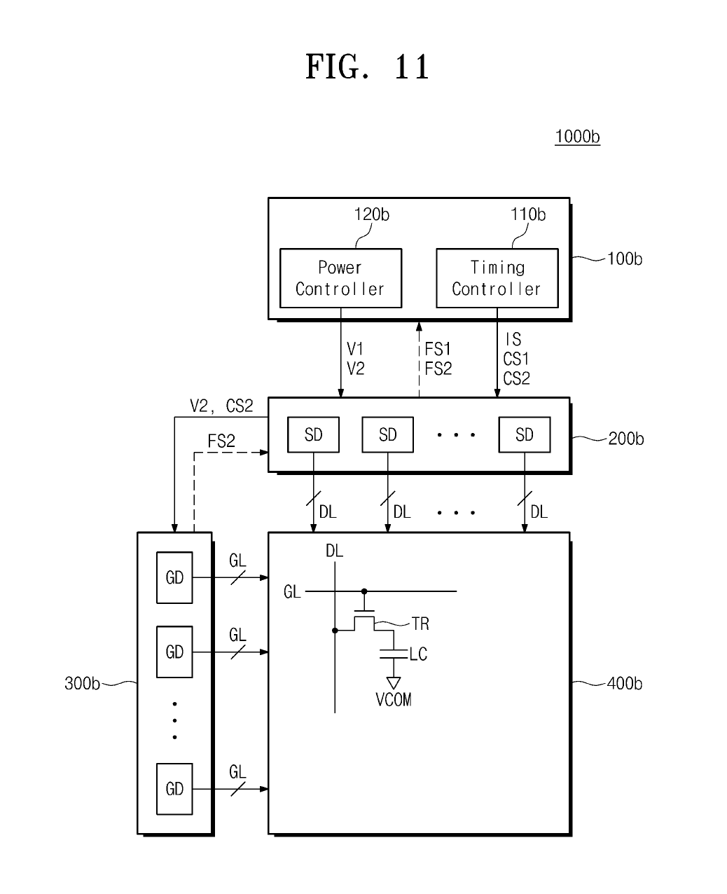

FIG. 11 is a block diagram of a display device according to an exemplary embodiment. Referring to FIG. 11, the display device 1000b includes a control unit 100b, a data driving unit 200b, a gate driving unit 300b, and a display panel 400b.

As described with reference to FIG. 1, the source driving circuits SD of the data driving unit 200b may transmit a first feedback signal FS indicating the input level of the first voltage V1 to the control unit 100b. As described with reference to FIG. 10, the gate driving circuits GD of the gate driving unit 300b may transmit a second feedback signal FS2 indicating the input level of the second voltage V2 to the control unit 100b through the data driving unit 200b. In certain configurations, the feedback signal FS2 may be transmitted to the control unit 100b directly. The power controller 120b may control the output level of the first voltage V1 based on the first feedback signal FS1. The power controller 120b may control the output level of the second voltage V2 based on the second feedback signal FS2.

According to various exemplary embodiments of the inventive concept, the input level of the voltage V1 or V2 supplied to the driving circuit SD or GD of the display device 1000, 1000a or 1000b is controlled to be a normal level. Thus, the display device 1000, 1000a or 1000b having enhanced reliability is provided.

According to one or more exemplary embodiments, a power controller is configured to adjust an output voltage based on a feedback signal provided from a driving circuit. Thus, since the level of the voltage input to the driving circuit is adjusted to be a desired level, a display device having enhanced reliability is provided.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A display device comprising:
a display panel comprising a plurality of pixels;
a driving circuit configured to control the plurality of pixels; and
a power controller configured to apply an output voltage to the driving circuit and to receive a feedback signal indicating an input level of the output voltage applied at an input of the driving circuit,
wherein the power controller is configured to adjust an output level of the output voltage in response to the feedback signal.

2. The display device of claim 1, wherein the power controller increases the output level of the output voltage to a value higher than a desired level to allow the input level of the output voltage indicated by the feedback signal to reach the desired level.

3. The display device of claim 1, wherein the driving circuit comprises a level detector configured to detect the input level of the output voltage supplied from the power controller, and
the driving circuit is configured to output a detection result from the level detector as the feedback signal through a feedback output pin.

4. The display device of claim 3, wherein the power controller is configured to receive the feedback signal directly through a feedback input pin connected to the feedback output pin of the driving circuit.

5. The display device of claim 3, further comprising a timing controller configured to output an image signal and control signal to the driving circuit,
wherein the timing controller is configured to receive the feedback signal through a first communication pin and transmit a received feedback signal to the power controller through a second communication pin.

6. The display device of claim 5, wherein the timing controller is configured to receive the feedback signal from the driving circuit through an inter-Integrated circuit (I2C) communication pin.

7. The display device of claim 5, wherein the timing controller is configured to transmit the received feedback signal to the power controller through an inter-Integrated circuit (I2C) communication pin.

8. The display device of claim 1, further comprising a voltage divider connected to a voltage input pin of the driving circuit,
wherein the power controller is configured to receive a voltage divided by the voltage divider as the feedback signal directly through a feedback input pin, the voltage divided by the voltage divider corresponding to a voltage at a node between a first resistor and a second resistor,
wherein the output voltage is configured to be applied at an end of the first resistor and an end of the second resistor is grounded.

9. The display device of claim 1, further comprising a plurality of driving circuits,
wherein the driving circuit configured to transmit the feedback signal has a longest distance from the power controller among the plurality of driving circuits.

10. The display device of claim 1, further comprising a plurality of driving circuits,
wherein the driving circuit configured to transmit the feedback signal has a shortest distance from the power controller among the plurality of driving circuits.

11. The display device of claim 1, further comprising a plurality of driving circuits,
wherein the driving circuit configured to transmit the feedback signal has an intermediate distance from the power controller among the plurality of driving circuits.

12. The display device of claim 1, further comprising a plurality of driving circuits,
wherein the power controller is configured to adjust the output level of the output voltage in response to a feedback signal indicating an input level of the output voltage at the input of the driving circuit and a plurality of feedback signals indicating input levels of the output voltage at the respective input of a plurality of other driving circuits, respectively.

13. The display device of claim 12, wherein the power controller is configured to adjust the output level of the output voltage based on a feedback signal indicating a lowest level among the feedback signal and the plurality of feedback signals.

14. The display device of claim 12, wherein the power controller is configured to adjust the output level of the output voltage based on a feedback signal indicating a highest level among the feedback signal and the plurality of feedback signals.

15. The display device of claim 12, wherein the power controller is configured to adjust the output level of the output voltage based on an average value of levels that the feedback signal and the plurality of feedback signals indicate.

16. The display device of claim 1, wherein the driving circuit is configured to drive data lines connected to the plurality of pixels, respectively.

17. The display device of claim 1, wherein the driving circuit is connected to a gate driving circuit configured to feed gate signals to gate lines connected to the plurality of pixels, respectively.

18. A display device comprising:
a display panel comprising a plurality of pixels, each pixel being connected to a drain electrode of a transistor;
a data driving circuit connected to a data line connected to a source electrode of the transistor to control the plurality of pixels;
a gate driving circuit connected to a gate line connected to a gate electrode of the transistor to provide a gate signal; and
a power controller configured to apply an output voltage to the data driving circuit and to receive a feedback signal from at least one of the data driving circuit and the gate driving circuit,
wherein the power controller is configured to adjust an output level of the output voltage in response to the feedback signal.

19. The display device of claim 18, wherein the data driving circuit comprising a plurality of source driving circuits, and
wherein at least one of the source driving circuits comprises a level detector to detect an input level of the output voltage at an input of the at least one of the source driving circuits.

20. A display device comprising:
a display panel comprising a plurality of pixels, each pixel being connected to a drain electrode of a transistor;
a data driving circuit connected to a data line connected to a source electrode of the transistor to control the plurality of pixels;
a gate driving circuit connected to a gate line connected to a gate electrode of the transistor to provide a gate signal;
a timing controller to receive a feedback signal from at least one of the data driving circuit and the gate driving circuit; and
a power controller configured to apply an output voltage to the data driving circuit and to adjust an output level of the output voltage in response to the feedback signal.
